(19) United States
(12) Patent Application Publication
(10) Pub. No.: US 2012/0213290 A1
(43) Pub. Date: Aug. 23, 2012

(54) Parallel video decoding

(75) Inventors: Ola Hugosson, Lund (SE); Dominic Hugo Symes, Cambridge (GB)

(73) Assignee: ARM Limited, Cambridge (GB)

(21) Appl. No.: 13/317,466

(22) Filed: Oct. 19, 2011

(30) Foreign Application Priority Data
Feb. 18, 2011 (GB) 1102836.2

(51) Int. Cl. H04N 7/26; H04N 7/30; H04N 7/32

(52) U.S. Cl. 375/240.24; 375/240.25; 375/240.16; 375/240.18; 375/E07.027; 375/E07.123; 375/E07.226

(57) ABSTRACT

A video decoding apparatus and method are disclosed. The video decoding apparatus comprises at least one parsing unit configured to receive input video data as an encoded video bitstream which contains sequential internal dependencies. The at least one parsing unit is configured to perform a parsing operation on the encoded video bitstream to generate an intermediate representation of the input video data in which at least a subset of the sequential internal dependencies are resolved. The intermediate representation of the input video data can be stored in a buffer. The video decoding apparatus further comprises a reconstruction unit configured to retrieve in parallel a plurality of input streams of the intermediate representation and to perform a decoding operation on the plurality of input streams in parallel to generate decoded output video data.

### FIELD OF THE INVENTION

The present invention relates to a video decoding apparatus which is configured to receive input video data as an encoded video bitstream and to perform a decoding operation to generate decoded output video data. More particularly, the present invention relates to the parallelization of aspects of the data processing performed by the video decoding apparatus.

### BACKGROUND OF THE INVENTION

Contemporary video encoding formats place significant processing demands on the video decoding apparatuses configured to decode the encoded video into a decoded output for display. For example, due to the encoding efficiency which may be thereby achieved, an encoded video bitstream may contain many sequential internal dependencies which must be resolved for the encoded video bitstream to be decoded for display.

Furthermore, the current trend is for more and more information to be incorporated into an encoded video bitstream to enable higher qualities of video to be transmitted via the finite and fallible resources of the transmission media via which such encoded video bitstreams are communicated. Given the growing complexity of contemporary encoded video, with the consequent performance demands imposed on video decoding apparatuses, the opportunities for parallelizing the decoding process, for example sharing the process out across a multi-core system, have been explored. “Evaluation of data-parallel splitting approaches for H.264 decoding”, F. Seitner et al., MoMM 2008, Nov. 24-26, 2008, Linz, Austria (retrieved from http://publik.tuwien.ac.at/files/PubDat_{—}168831.pdf) explores various methods for accomplishing data-parallel splitting in strongly resource-restricted environments. However, the subdivision of the decoding task between multiple processor cores is a complex task and significant challenges in terms of the inter-core communication and data management must be addressed.

It is known to sub-divide a video decoding process into two stages, namely a initial parsing stage and a subsequent reconstruction stage. As part of such an approach, UK published patent application GB2,471,887 describes techniques for at least partially compressing the output of the parsing stage. Since the output of the parsing stage is typically buffered before being handled by the reconstruction stage, the compression of the parser output can be beneficial both in terms of the required buffer size and in terms of the transfer bandwidth. However the techniques disclosed are only described in terms of a single decoding pipeline, rather than a parallelized approach.

The complexity of contemporary video encoding has been further increased with the introduction of scalable video coding (SVC). SVC (an extension of the H.264/MPEG-4 AVC standard) introduces a layered coding technique according to which a given picture of a video sequence can be encoded in multiple layers, the layers allowing for example a range of spatial resolutions and image qualities. This technique enables one or more subset bitstreams within a high quality video bitstream to be decoded at a correspondingly lower level of complexity and reconstruction quality. This can allow packets from the full bitstream to be dropped (for example due to network capacity limitations) and the end decoder can then decode the best available video that remains.

This arrangement is schematically illustrated in FIG. 1 wherein a picture of a video stream is encoded as a base layer (B) and a number of enhancement layers (E₁, E₂, E₃ etc.). The base layer B represents the lowest level of quality and resolution, whilst each enhancement layer adds to the quality and/or resolution. The arrows between the layers in FIG. 1 indicate a chain of dependencies, layer B being required to decode layer E₁, layer E₁ being required to decode E₂ etc. As mentioned above, the enhancement layers may represent spatial (picture size) scalability, as is schematically illustrated in FIG. 2A. Alternatively, as shown in FIG. 2B, the enhancement layers may represent a sequence of increasing image qualities (e.g. poor, medium, good).

The complexity of SVC encoding not only further adds to the processing burden for a video decoding apparatus, but the additional internal dependencies which SVC introduces into an encoded video bitstream (inter-layer prediction) further adds to the complexity of parallelizing the decoding process. “Mapping scalable video coding decoder on multi-core stream processors”, Yu-Chi Su, et al.; DSP/IC Design Lab, Graduate Institute of Electronic Engineering, National Taiwan University, Taipei, Taiwan (retrieved from http://gra103.aca.ntu.edu.tw/gdoc/98/D96921032a.pdf) discusses some approaches to parallelizing an SVC decoder on a multi-core processor platform.

However, it would be desirable to provide a technique which enabled an encoded video bitstream such as those described above which contains sequential internal dependencies to be at least partly parallelized to improve the performance of the decoder, without encountering many of the complexities associated with distributing the decoding task across multiple processor cores.

### SUMMARY OF THE INVENTION

Viewed from a first aspect, the present invention provides a video decoding apparatus comprising at least one parsing unit configured to receive input video data as an encoded video bitstream, wherein said encoded video bitstream contains sequential internal dependencies, said at least one parsing unit configured to perform a parsing operation on said encoded video bitstream to generate an intermediate representation of said input video data, wherein at least a subset of said sequential internal dependencies are resolved in said intermediate representation, said at least one parsing unit configured to output said intermediate representation of said input video data for storing in a buffer; and a reconstruction unit configured to retrieve in parallel a plurality of input streams of said intermediate representation from said buffer and to perform a decoding operation on said plurality of input streams in parallel to generate decoded output video data.

Accordingly a video decoding apparatus is provided in which its subcomponents can be fundamentally categorised into two sections. The first section comprises at least one parsing unit which is configured to receive the input video data. The at least one parsing unit generates an intermediate representation of the input video data in which at least a subset of the sequential internal dependencies present in the encoded video bitstream are resolved. The result of this first section is then made available, by storage in an intermediate buffer, to the second section, namely a reconstruction unit. The reconstruction unit is configured to retrieve in parallel a plurality of input streams of the intermediate representation and to perform a decoding operation in parallel on that plurality of input streams, thus generating the decoded output video data.

Hence, because the reconstruction unit is configured to perform its decoding operation on video data stored in the intermediate representation in which at least a subset of the sequential internal dependencies have been resolved, this allows at least some parallelization of the decoding operation to be introduced. Furthermore, by decoupling the operation of the at least one parsing unit from the reconstruction unit, by storing the intermediate representation in a buffer, the rate at which each unit operates is less dependent on the other. For example, the parsing rate can be adapted to the input bitstream rate and the reconstruction (rendering) rate can be adapted in dependence on the image size and frequency.

In one embodiment said input video data comprises multiple layers of a scalable video stream, and each stream of said plurality of input streams represents a layer of said multiple layers. Accordingly, when the input video data is a scalable video stream, the reconstruction unit can be configured to decode the layers of the scalable video stream in parallel, by accessing the intermediate representation of each layer in the buffer. Arranging the reconstruction unit to decode the layers of the scalable video stream in parallel can be advantageous both in terms of system performance and in terms of hardware reuse advantages. For example, in terms of system performance, the parallel decoding of the layers means that the reconstruction unit can process all layers of each macroblock (16×16 tile within a given picture) before moving to the next macroblock. This improves data locality and reduces memory access bandwidth. On the other hand in terms of hardware reuse, the parallelization of the decoding performed in the reconstruction unit means that only some hardware units have to be replicated (e.g. inverse quantize) whilst other layers (e.g. motion compensation) need only be provided once. This reduces the area and power consumption of the reconstruction unit. Furthermore, because the transform coefficients for a sequence of related layers can be defined in relative terms in the intermediate format (e.g. an absolute value for a base layer, with differences for each subsequent enhancement layer encoded as a difference to the previous layer), these can be stored and accumulated inside the reconstruction unit more efficiently (for example in a compressed form), reducing memory bandwidth compared to accumulating the coefficients for each layer in turn. Furthermore, given that the transform coefficients for the multiple layers will typically have a significant degree of correlation with one another, the relative differences will generally be small values, which compress more efficiently than the full, absolute value for each layer.

In one embodiment said multiple layers represent a set of picture representations having a same resolution and a varying quality with respect to one another. Quality layers which have the same resolution are particularly well suited to parallel decoding in the reconstruction unit because the macroblock subdivision within each picture maps directly between each layer.

In one embodiment said multiple layers comprise an independently encoded base layer and a dependently encoded enhancement layer, said dependently encoded enhancement layer being encoded with reference to said independently encoded base layer. The dependency between the dependently encoded enhancement layer and the independently encoded base layer means that, once these layers have been written into the intermediate representation, they are apt to be decoded in parallel with one another, since the dependencies between these two layers means that memory access bandwidth is reduced if these layers are decoded in parallel. For example, the transform coefficients (in the intermediate representation format) can be stored (for example in compressed and/or quantized form) and accumulated inside the reconstruction unit, meaning that memory bandwidth is reduced compared to accumulating the coefficients for each layer in turn.

It should be understood that the invention is not limited to only a single dependently encoded enhancement layer, and in one embodiment said multiple layers comprise at least one further dependently encoded enhancement layer, said at least one further dependently encoded enhancement layer being encoded with reference to a preceding dependently encoded enhancement layer.

In one embodiment, said reconstruction unit is configured, if said multiple layers of said input video data are more numerous than said plurality of input streams, to perform more than one iteration of said decoding operation to decode said multiple layers. Hence, although the reconstruction unit may be arranged to be able to read in a particular number of input streams, this does not mean that the reconstruction unit is only able to decode a scalable video stream which is limited to a corresponding number of layers. Instead, the reconstruction unit can be configured to read in a set of input streams on a first iteration, decoding those layers in parallel with one another, and to subsequently read in the further layers in one or more further iterations (each of which may include parallel decoding).

The sequential internal dependencies in the encoded video stream may take a number of forms, but in one embodiment said sequential internal dependencies in said encoded video bitstream comprise at least one entropy decoding dependency. Alternatively, or in addition, in one embodiment the sequential internal dependencies in said encoded video bitstream comprise at least one motion vector dependency.

In one embodiment said encoded video bitstream represents said input video data as a sequence of macroblocks, and said reconstruction unit is configured to generate said decoded output video data as a sequence of decoded macroblocks. Handling the video data in terms of macroblocks is particularly beneficial in the context of the parallel decoding of input streams in the reconstruction unit, since this allows parallel decoding elements in the reconstruction unit to more easily align their decoding activities (for example with each handling a different layer in a scaleable video example) with one another, and to thus derive the above-mentioned benefits of data locality and memory bandwidth reduction.

The intermediate representation may take a number of forms, but in one embodiment said intermediate representation comprises at least a macroblock type for each macroblock in said sequence. In one embodiment said intermediate representation comprises a motion vector for at least one macroblock in said sequence. Whilst not all macroblocks will contain a motion vector (for example an independently encoded picture will not), dependently encoded macroblocks (for example P and B type macroblocks) will have a motion vector. Identifying this motion vector at the parsing stage enables such a macroblock to be more quickly decoded at the reconstruction stage. In one embodiment said intermediate representation comprises a set of transform coefficients for at least one macroblock in said sequence. The presence of a set of transform coefficients in the intermediate format means that the reconstruction stage can make immediate use of these values, without having to first derive them.

When the intermediate representation comprises a set of transform coefficients for a macroblock in the sequence, the at least one parsing unit may be configured to output said set of transform coefficients for said at least one macroblock in said sequence in a compressed format. It has been found that transform coefficients are particularly well suited to compression and therefore memory bandwidth may be saved by storing this part of the intermediate representation in a compressed form. It will be recognised that the particular compressed format might take a number of forms, but in one embodiment said compressed format comprises a set of signed exponential-golomb codes. It has been found that, for a decode operation, the set of transform coefficients for each macroblock often contains a significant number of zero values, and signed exponential golomb codes provide a particularly efficient mechanism for compressing a set of coefficients which include a significant number of zero values. However, it should be noted that the use of signed exponential golomb codes is not essential, and any other appropriate coding could be used, for example more general Huffman or arithmetic coding techniques could be used.

In one embodiment said video decoding apparatus comprises at least two parsing units, said at least two parsing units configured to at least partially parallelize said parsing operation. Accordingly, whilst in some embodiments only a single parsing unit is provided, in other embodiments more than one parsing unit may be provided. In particular the at least partial parallelization of the parsing operation that is then possible can enable a more efficient configuration of the video decoding apparatus. For example, the choice of how many parsing units to provide can influence the rate at which the input video data can be parsed. Depending on the configuration of the reconstruction unit, and in particular the speed at which the reconstruction unit can render decoded video, it may be advantageous to provide two (or more) parsing units, in order to enhance the rate at which the video decoder can parse, and ultimately the throughput of the whole video decoding apparatus.

The input video data may be distributed between multiple parsing units in a number of ways, but in one embodiment said at least two parsing units are each configured to perform said parsing operation on a given layer of said scalable video stream. When the input video data is a scalable video stream having multiple layers, a particularly efficient parsing operation may be enabled by configuring the subdivision of the input video data between the at least two parsing units to be done on a layer basis. In particular, this may enable the writing of the intermediate representation into the buffer to be particularly efficiently performed. In a further such variant, in one embodiment said at least two parsing unit are each configured to perform said parsing operation on a slice basis in a given a layer of said scalable video stream.

In one embodiment said reconstruction unit comprises a dequantization unit for each input stream of said plurality of input streams. The dequantization of encoded video data is typically specific to each individual stream of video data and hence the parallelization of the decoding operation in the reconstruction unit is supported by the provision of a dequantization unit for each input stream.

Although some components may need to be provided individually for each input stream, in some embodiments said reconstruction unit comprises at least one shared decoding component, said shared decoding component being used in said decoding operation for all of said plurality of input streams. Thus, decoding components (such as motion compensation or resample) which can be shared between multiple streams need not be repeated, thus saving area and power.

In one embodiment said reconstruction unit comprises at least two deblocking units. The provision of more than one deblocking unit may be advantageous in terms of the parallelization in the reconstruction unit, for example where more than one temporal dependency is encoded for a given set of quality layers. Providing more than one deblocking unit enables the reconstruction unit to maintain the parallelized decoding even if such multiple temporal dependencies are present.

It will be appreciated that the reconstruction unit could be configured to receive various numbers of input streams, but in one embodiment said plurality of input streams comprises at least three input streams. Where the input streams might otherwise be decoded in series, the parallel decoding of the input streams represent a performance enhancement and this performance enhancement is particularly noticeable when the reconstruction unit is configured to decode at least three input streams.

In one embodiment said at least one parsing unit is configured to output said intermediate representation of said input video data for storing in a plurality of buffers, and said reconstruction unit is configured to retrieve each of said plurality of input streams from a respective buffer of said plurality of buffers. Providing a buffer which corresponds to each plurality of input streams means that the writing of the intermediate representation by the parsing unit and the retrieval of the intermediate representation by the reconstruction unit may be efficiently performed.

Viewed from a second aspect the present invention provides a method of video decoding, comprising the steps of: receiving input video data as an encoded video bitstream, wherein said encoded video bitstream contains sequential internal dependencies, performing a parsing operation on said encoded video bitstream to generate an intermediate representation of said input video data, wherein at least a subset of said sequential internal dependencies are resolved in said intermediate representation, outputting said intermediate representation of said input video data for storing in a buffer; and retrieving in parallel a plurality of input streams of said intermediate representation from said buffer and performing a decoding operation on said plurality of input streams in parallel to generate decoded output video data.

Viewed from a third aspect the present invention provides a video decoding apparatus comprising at least one parsing means for receiving input video data as an encoded video bitstream, wherein said encoded video bitstream contains sequential internal dependencies, said at least one parsing means for performing a parsing operation on said encoded video bitstream to generate an intermediate representation of said input video data, wherein at least a subset of said sequential internal dependencies are resolved in said intermediate representation, said at least one parsing means for outputting said intermediate representation of said input video data for storing in a buffer; and reconstruction means for retrieving in parallel a plurality of input streams of said intermediate representation from said buffer and performing a decoding operation on said plurality of input streams in parallel to generate decoded output video data.

### BRIEF DESCRIPTION OF THE DRAWINGS

The present invention will be described further, by way of example only, with reference to embodiments thereof as illustrated in the accompanying drawings, in which:

FIG. 1 schematically illustrates a known scalable video stream structure;

FIG. 2A schematically illustrates a known set of spatial layers in a scalable video stream;

FIG. 2B schematically illustrates a known set of quality layers in a scalable video stream;

FIG. 3 schematically illustrates an approach to parallel reconstruction of a scalable video stream in one embodiment;

FIG. 4 schematically illustrates a video decoding apparatus having more than one parsing unit in one embodiment;

FIG. 5A schematically illustrates a set of intermediate format buffers in memory in one embodiment;

FIG. 5B schematically illustrates in more detail one of the intermediate format buffers of FIG. 5A;

FIG. 6 schematically illustrates a video decoding apparatus and its internal data flow in one embodiment;

FIG. 7 schematically illustrates some subcomponents of a reconstruction unit in a video decoding apparatus in one embodiment; and

FIG. 8 schematically illustrates a series of steps taken in a video decoding apparatus in one embodiment.

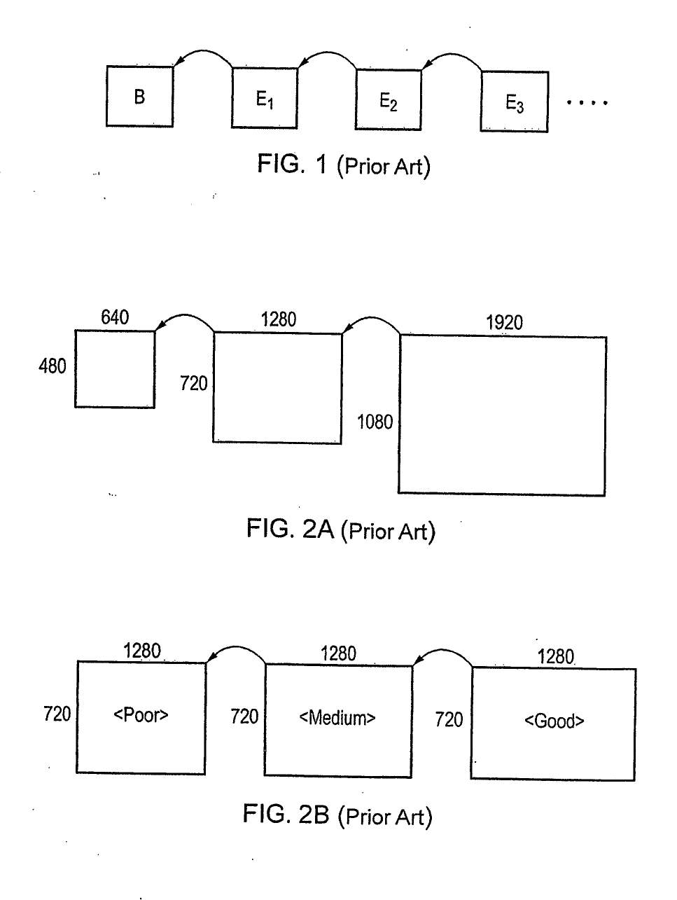

### DESCRIPTION OF EMBODIMENTS

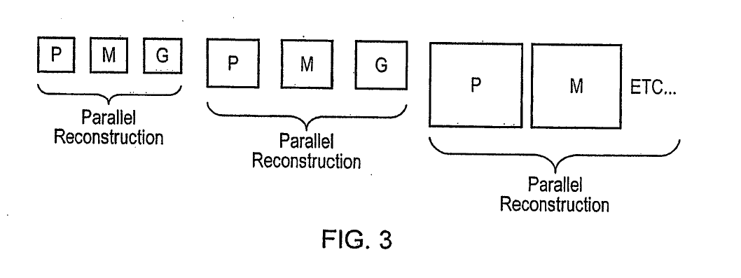

FIG. 3 schematically illustrates a set of layers in a scalable video stream. Viewed from left to right, the set of layers increase in both resolution (represented by the size of each square) and image quality (indicated by the letters P, M and G i.e. poor, medium and good). As will be discussed in more detail in the following, embodiments of the present invention parallelize the decoding of input video data having the structure shown in FIG. 3 by reconstructing the three quality layers (poor, medium and good) at each resolution level in parallel.

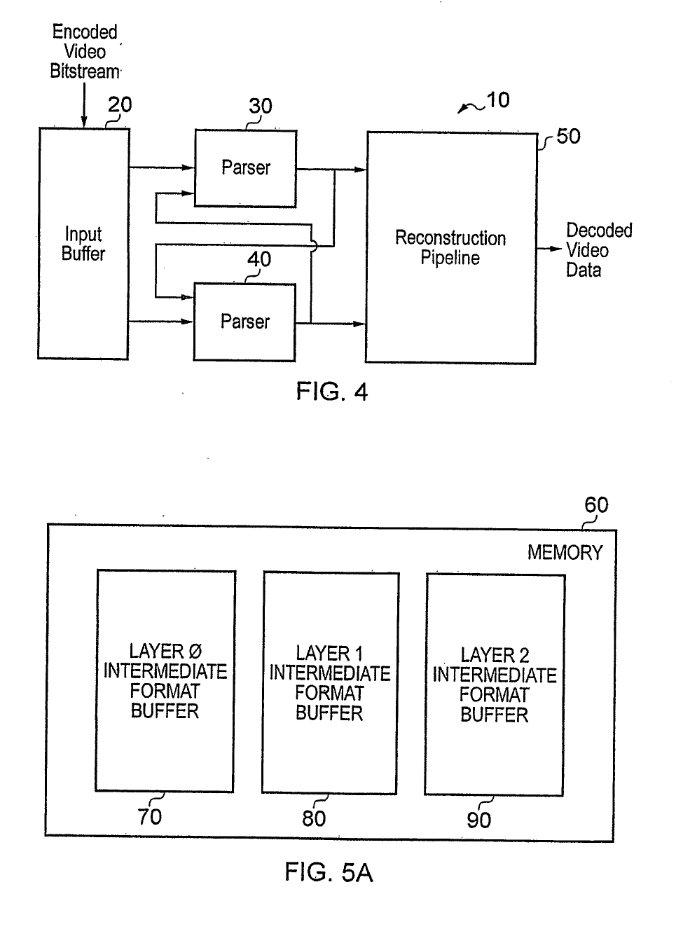

FIG. 4 schematically illustrates an image decoding apparatus in one embodiment. The video decoding apparatus 10 receives an encoded video bitstream which is temporarily buffered in input buffer 20. The data processing performed by the video decoding apparatus is then performed in two stages: a first parsing stage and a subsequent reconstruction stage. In the illustrated embodiment in FIG. 4 the parsing stage is performed by parsing units 30 and 40, whilst the reconstruction is performed within the reconstruction pipeline 50. The arrows connecting the illustrated units in FIG. 4 are intended to illustrate the data flow between the illustrated units at a conceptual level and this should not be interpreted as a strict representation of the physical configuration of the device. The parsing units 30, 40 retrieve the encoded video bitstream from the input buffer 20 and perform a parsing operation thereon in order to generate an intermediate representation of the encoded video bitstream received. This intermediate representation is stored in a buffer from where it is retrieved as a plurality of input streams for the reconstruction pipeline 50, which performs decoding operations to generate the decoded apparatus output video data. Hence it will be understood that the arrows leading from the parsers 30, 40 to reconstruction pipeline 50 should not be interpreted as a direct data path. The configuration of the parsing units 30, 40 illustrates that these parsing units are configured to operate in parallel to one another, but furthermore, that on the one hand the operation of the parsing unit 40 may be dependent on the result of the parsing operation performed by parser 30, whilst on the other hand the operation of the parsing unit 30 may be dependent on the result of the parsing operation performed by parser 40. Indeed, although not illustrated in FIG. 4, further parsing units could also be provided with the potential for the parsing operation of a further parsing unit being dependent on the output of either or both of parsers 30 and 40, and vice versa. This dependency between the operation of the two illustrated parsing units may for example result from the encoded video bitstream being a scalable video stream comprising multiple layers. In this situation, parser 30 may be configured to perform its parsing operation on a base layer of those multiple layers, whilst parser 40 is configured to perform its parsing operation on a dependently encoded enhancement layer, the parsing of the dependently encoded enhancement layer requiring some input from the parsing operation being performed on the independently encoded base layer (for example, the identification of its MBInfo part—see below). Further, where the scalable video stream comprises more than two layers, parser 30 may further be configured to perform its parsing operation on a further, dependently encoded enhancement layer, the parsing of this dependently encoded enhancement layer requiring some input from the parsing operation performed on the previous dependently encoded base layer (by parser 40). This iterative sequence of dependencies can extend for as many layers as exist in the scalable video stream.

Furthermore in this example, whilst parser 30 is configured to output an intermediate representation of the input video data related to the base layer (and any further enhancement layers it handles), parser 40 is configured to generate an intermediate representation of the input video data related to the enhancement layer (and any further enhancement layers it handles). The reconstruction pipeline 50 is then configured to retrieve the intermediate representations of at least two layers in parallel, to perform its decoding operation on these parallel input streams, as will be discussed in more detail in the following.

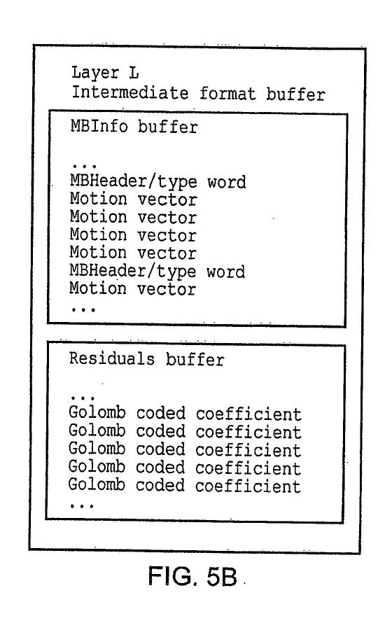

FIG. 5A schematically illustrates an arrangement of the buffer in memory into which the parsing unit (or units) writes the intermediate representation of the input video data and out of which the reconstruction unit retrieves in parallel a plurality of input streams in that intermediate representation in order to perform the decoding operation. In the example illustrated in FIG. 5A, the memory 60 comprises three individual buffers 70, 80 and 90, each buffer being configured for the temporary storage of the intermediate representation of the input video data related to one layer of the received scalable video stream. As illustrated, buffer 70 is an intermediate format buffer for layer 0, buffer 80 is an intermediate format buffer for layer 1 and buffer 90 is an intermediate format buffer for layer 2. For example, layer 0 could represent an independently encoded base layer, whilst layers 1 and 2 could represent dependently encoded enhancement layers.

FIG. 5B schematically illustrates in more detail example contents of one of the intermediate format buffers 70, 80 and 90 of FIG. 5A. As can be seen, in this example, each buffer comprises two buffers: an MBInfo buffer and a residuals buffer. Into the MBInfo buffer, the parsing unit handling this layer writes a stream of data comprising macroblock headers (indicating inter alia the macroblock type) and motion vectors. This MBInfo is made use of by a parsing unit which parses a layer dependent on this layer. For example, if parser 30 (FIG. 4) generates the layer L intermediate format data shown in FIG. 5B, parser 40 will reference this buffer when parsing layer L+1, in order to resolve the MBInfo-related dependencies.

Into the residuals buffer, the parsing unit handling this layer writes a stream of data comprising transform coefficients (in an exponential-golomb coded format, due to the data size reduction thereby acheived) for this layer. Note that both MBInfo data and residual data from a given intermediate format buffer are read in as part of the “input stream” for the reconstruction unit. In other words, the reconstruction unit reads in an input stream from at least two intermediate format buffers and each stream comprises both MBInfo data and residual data.

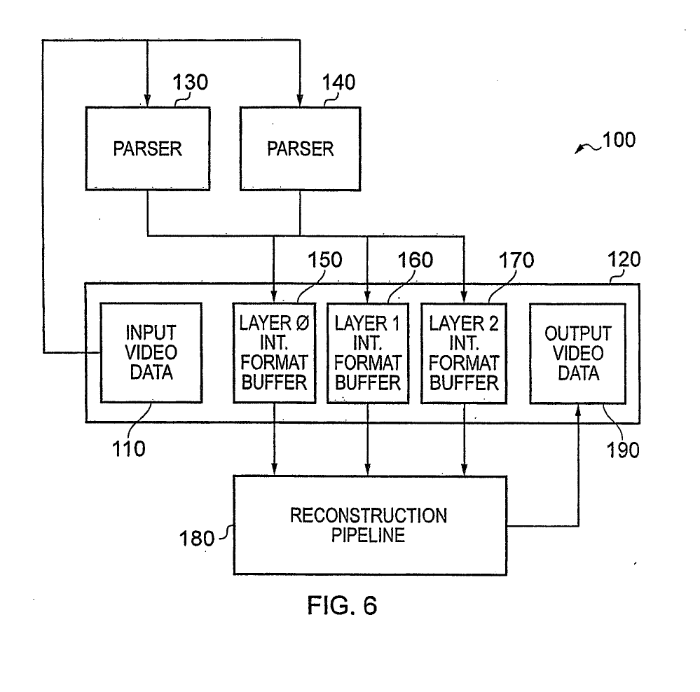

FIG. 6 schematically illustrates the data flow in a video decoding apparatus in one embodiment. Input video data 110 is temporarily buffered in memory 120 before being retrieved by parsing units 130, 140. The parsing units perform a parsing operation on the input video data and the intermediate representation thereby generated is written into the corresponding intermediate representation (intermediate format) buffers in memory. Each parser can also access previously parsed information in the buffers as required for its own current parsing operation. In the illustrated example the video decoding apparatus is configured to decode a scalable video stream which comprises three quality layers (0, 1, 2) and video data for each layer is written in the intermediate representation into its corresponding buffer 150, 160 or 170. The reconstruction pipeline 180 is configured to access the intermediate format buffers in parallel to retrieve three input streams of the intermediate representation data and to perform its decoding operation on these three input streams in parallel to generate the decoded output video data 190 which is written into memory 120.

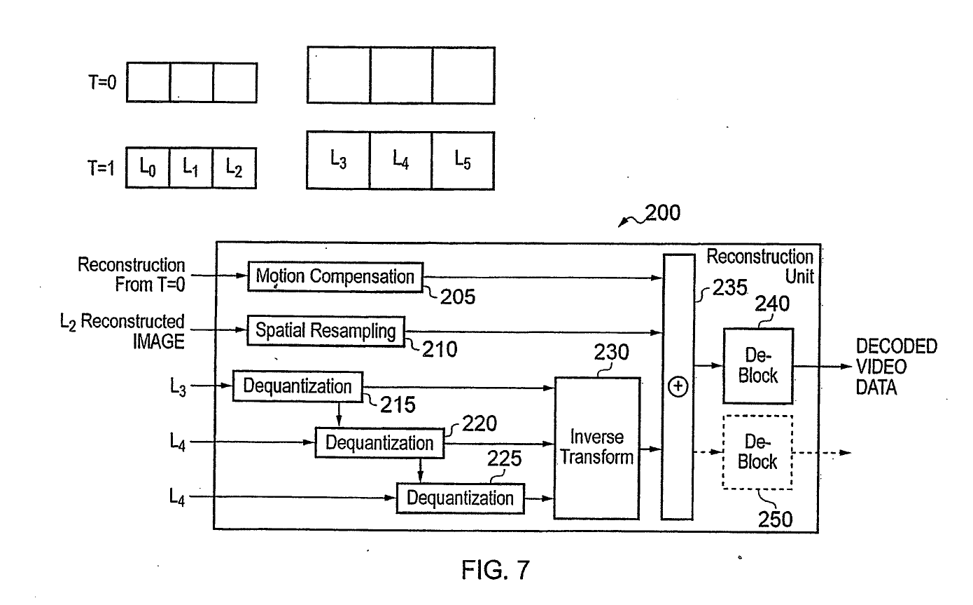

FIG. 7 schematically illustrates the configuration of a reconstruction unit in one embodiment. The reconstruction unit 200 is configured to retrieve three input streams of video data in the above mentioned intermediate representation from buffers in memory in order to perform a decoding operation in parallel on those three input streams. For example, as illustrated, the reconstruction unit can retrieve intermediate representation data for layers L₃, L₄ and L₅ which correspond to three quality layers for a given picture. In order to perform the decoding operation on the intermediate representation of these three layers, the reconstruction unit also makes reference to the preceding three quality layers in the input video data corresponding to a lower resolution of the same picture. In addition, the reconstruction unit 200 also refers to decoded video data from a previous picture. These various layers are schematically illustrated by the sets of layers corresponding to time T=0 and to time T=1 in the upper part of FIG. 7.

Hence, the inputs into reconstruction unit 200 comprise the three input streams of the intermediate representation of the layers being decoded (L₃, L₄ and L₅), previously decoded (reconstructed) output video data from T=0 and the previously decoded (reconstructed) video data from the last (i.e. highest quality) layer of the set of lower resolution layers for this picture (namely L₂). The reconstructed video data from T=0 forms the input for motion compensation unit 205, whilst the reconstructed video data from the L₂ layer forms the input to the spatial resampling unit 210. The spatial resampling unit is configured to take a smaller picture (typically the highest quality picture at the smaller picture size) and using upsampling filters to convert it into a version which matches the current (larger) picture size. Each of the input streams of the intermediate representation (L₃, L₄ and L₅) are input into a corresponding dequantization unit 215, 220, 225. To allow for possible dependencies between the dequantization processes performed by dequantization units 215, 220, 225, these units are schematically illustrated as offset from one another, implying that the result of dequantization in unit 215 can be fed into dequantization unit 220 and similarly the output of dequantization unit 220 can be fed into the input of dequantization unit 225.

The results of the three dequantization units are combined in inverse transform unit 230. The results of the motion compensation 205, spatial resampling 210 and inverse transform 230 are brought together by combining unit 235. Finally, deblocking is performed by deblocker 240 to generate the output decoded video data. It will be appreciated that the description of the components of the reconstruction unit 200 is restricted to the schematic nature of the figure and a detailed description of the reconstruction process is not expounded here for the sake of clarity. The skilled person will be familiar with the detailed implementation of the relatively high level steps described. Reconstruction unit 200 may optionally comprise a further deblocking unit 250 to enable the reconstruction unit to handle more than one temporal dependency (i.e. between T=0 and T=1).

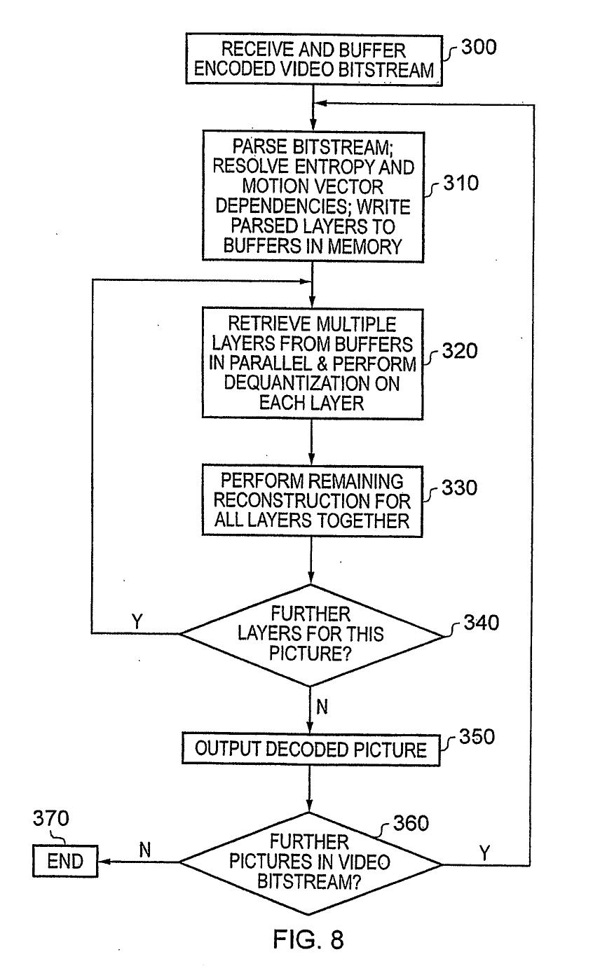

An overview of the steps taken in a video decoding apparatus according to one embodiment are schematically set out in FIG. 8. At step 300 the video decoding apparatus receives and buffers an encoded video bitstream. Then at step 310 the video decoding apparatus parses the encoded video bitstream, resolving the entropy and motion vector dependencies therein and writes the parsed layers out to corresponding buffers in memory. The reconstruction begins at step 320, where the reconstruction unit retrieves multiple layers from the buffers in parallel and performs a dequantization process on each layer and then at step 330 performs the remaining reconstruction steps for each of the retrieved layers together. At step 340 it is determined if there are further layers to be reconstructed for this picture. If there are, the flow returns to step 320 and any further layers are decoded. If there are no further layers for this picture then the flow proceeds to step 350 at which the decoded video data for this picture is output. At step 360 it is determined if there are further pictures to be decoded in the video bitstream and if there are, the flow returns to step 310. Otherwise the flow concludes at step 370.

Hence, according to the present technique, when decoding an encoded video bitstream the parallelization of the reconstruction process is enabled by first performing a parsing process on the encoded bitstream, which removes at least some of the sequential internal dependencies. The result of the parsing process is an intermediate representation (format) which can be temporarily buffered. Parallelization of the reconstruction process takes place in that the reconstruction unit is configured to retrieve more than one input stream of the intermediate representation from the buffer and to decode those plural input streams in parallel.

A video decoding apparatus and method are disclosed. The video decoding apparatus comprises at least one parsing unit configured to receive input video data as an encoded video bitstream which contains sequential internal dependencies. The at least one parsing unit is configured to perform a parsing operation on the encoded video bitstream to generate an intermediate representation of the input video data in which at least a subset of the sequential internal dependencies are resolved. The intermediate representation of the input video data can be stored in a buffer. The video decoding apparatus further comprises a reconstruction unit configured to retrieve in parallel a plurality of input streams of the intermediate representation and to perform a decoding operation on the plurality of input streams in parallel to generate decoded output video data.

Although a particular embodiment has been described herein, it will be appreciated that the invention is not limited thereto and that many modifications and additions thereto may be made within the scope of the invention. For example, various combinations of the features of the following dependent claims could be made with the features of the independent claims without departing from the scope of the present invention.

1. A video decoding apparatus comprising:
at least one parsing unit configured to receive input video data as an encoded video bitstream, wherein said encoded video bitstream contains sequential internal dependencies,
said at least one parsing unit configured to perform a parsing operation on said encoded video bitstream to generate an intermediate representation of said input video data, wherein at least a subset of said sequential internal dependencies are resolved in said intermediate representation,
said at least one parsing unit configured to output said intermediate representation of said input video data for storing in a buffer; and
a reconstruction unit configured to retrieve in parallel a plurality of input streams of said intermediate representation from said buffer and to perform a decoding operation on said plurality of input streams in parallel to generate decoded output video data,
wherein said input video data comprises multiple lavers of a scalable video stream, and wherein each stream of said plurality of input streams represents a layer of said multiple layers.

2. (canceled)

3. The video decoding apparatus as claimed in claim 1, wherein said multiple layers represent a set of picture representations having a same resolution and a varying quality with respect to one another.

4. The video decoding apparatus as claimed in claim 1, wherein said multiple layers comprise an independently encoded base layer and a dependently encoded enhancement layer, said dependently encoded enhancement layer being encoded with reference to said independently encoded base layer.

5. The video decoding apparatus as claimed in claim 4, wherein said multiple layers comprise at least one further dependently encoded enhancement layer, said at least one further dependently encoded enhancement layer being encoded with reference to a preceding dependently encoded enhancement layer.

6. The video decoding apparatus as claimed in claim 1, wherein said reconstruction unit is configured, if said multiple layers of said input video data are more numerous than said plurality of input streams, to perform more than one iteration of said decoding operation to decode said multiple layers.

7. The video decoding apparatus as claimed in claim 1, wherein said sequential internal dependencies in said encoded video bitstream comprise at least one entropy decoding dependency.

8. The video decoding apparatus as claimed in claim 1, wherein said sequential internal dependencies in said encoded video bitstream comprise at least one motion vector dependency.

9. The video decoding apparatus as claimed in claim 1, wherein said encoded video bitstream represents said input video data as a sequence of macroblocks, and said reconstruction unit is configured to generate said decoded output video data as a sequence of decoded macroblocks.

10. The video decoding apparatus as claimed in claim 9, wherein said intermediate representation comprises at least a macroblock type for each macroblock in said sequence.

11. The video decoding apparatus as claimed in claim 9, wherein said intermediate representation comprises a motion vector for at least one macroblock in said sequence.

12. The video decoding apparatus as claimed in claim 9, wherein said intermediate representation comprises a set of transform coefficients for at least one macroblock in said sequence.

13. The video decoding apparatus as claimed in claim 12, wherein said at least one parsing unit is configured to output said set of transform coefficients for said at least one macroblock in said sequence in a compressed format.

14. The video decoding apparatus as claimed in claim 13, wherein said compressed format comprises a set of signed exponential-golomb codes.

15. The video decoding apparatus as claimed in claim 1, wherein said video decoding apparatus comprises at least two parsing units, said at least two parsing units configured to at least partially parallelize said parsing operation.

16. The video decoding apparatus as claimed in claim 15, wherein said input video data comprises multiple layers of a scalable video stream, and wherein each stream of said plurality of input streams represents a layer of said multiple layers, wherein said at least two parsing units are each configured to perform said parsing operation on a given layer of said scalable video stream.

17. The video decoding apparatus as claimed in claim 15, wherein said input video data comprises multiple layers of a scalable video stream, and wherein each stream of said plurality of input streams represents a layer of said multiple layers, wherein said at least two parsing unit are each configured to perform said parsing operation on a slice basis in a given a layer of said scalable video stream.

18. The video decoding apparatus as claimed in claim 1, wherein said reconstruction unit comprises a dequantization unit for each input stream of said plurality of input streams.

19. The video decoding apparatus as claimed in claim 1, wherein said reconstruction unit comprises at least one shared decoding component, said shared decoding component being used in said decoding operation for all of said plurality of input streams.

20. The video decoding apparatus as claimed in claim 1, wherein said reconstruction unit comprises at least two deblocking units.

21. The video decoding apparatus as claimed in claim 1, wherein said plurality of input streams comprises at least three input streams.

22. The video decoding apparatus as claimed in claim 1, wherein said at least one parsing unit is configured to output said intermediate representation of said input video data for storing in a plurality of buffers; and
said reconstruction unit is configured to retrieve each of said plurality of input streams from a respective buffer of said plurality of buffers.

23. A method of video decoding, comprising the steps of:
receiving input video data as an encoded video bitstream, wherein said encoded video bitstream contains sequential internal dependencies,
performing a parsing operation on said encoded video bitstream to generate an intermediate representation of said input video data, wherein at least a subset of said sequential internal dependencies are resolved in said intermediate representation,
outputting said intermediate representation of said input video data for storing in a buffer; and
retrieving in parallel a plurality of input streams of said intermediate representation from said buffer and performing a decoding operation on said plurality of input streams in parallel to generate decoded output video data,
wherein said input video data comprises multiple layers of a scalable video stream, and wherein each stream of said plurality of input streams represents a layer of said multiple layers.

24. A video decoding apparatus comprising:
at least one parsing means for receiving input video data as an encoded video bitstream, wherein said encoded video bitstream contains sequential internal dependencies,
said at least one parsing means for performing a parsing operation on said encoded video bitstream to generate an intermediate representation of said input video data, wherein at least a subset of said sequential internal dependencies are resolved in said intermediate representation,
said at least one parsing means for outputting said intermediate representation of said input video data for storing in a buffer; and
reconstruction means for retrieving in parallel a plurality of input streams of said intermediate representation from said buffer and performing a decoding operation on said plurality of input streams in parallel to generate decoded output video data,
wherein said input video data comprises multiple layers of a scalable video stream, and wherein each stream of said plurality of input streams represents a layer of said multiple layers.
